(19) United States
(12) Patent Application Publication
(10) Pub. No.: US 2023/0369725 A1
(43) Pub. Date: Nov. 16, 2023

(54) BUSBAR MODULE

(71) Applicant: Yazaki Corporation, Tokyo (JP)

(72) Inventors: Hirotaka MUKASA, Shizuoka (JP); Tatsuya OGA, Shizuoka (JP); Hirokuni KOIKE, Shizuoka (JP); Yoshiki AOSHIMA, Shizuoka (JP)

(73) Assignee: Yazaki Corporation, Tokyo (JP)

(21) Appl. No.: 18/308,354

(22) Filed: Apr. 27, 2023

(30) Foreign Application Priority Data
May 16, 2022 (JP) 2022-080406

(51) Int. Cl. H01M 50/507; H01R 25/16; H02G 5/02

(52) U.S. Cl. CPC H01M 50/507; H01R 25/161; H02G 5/02

(57) ABSTRACT

The present disclosure relates to a busbar module to be attached to a battery assembly in which a plurality of single cells are stacked. The busbar module includes a main line circuit body including a plurality of electric wires, and disposed to extend along a stacking direction of the plurality of single cells, a relay circuit body including a circuit board having a wiring pattern, the wiring pattern being electrically connected to at least one of the electric wires extending to branch from the main line circuit body, a busbar connected to an electrode of each of the plurality of single cells, an electronic component attached to a mounting face of the relay circuit body to connect the wiring pattern to the busbar, and a holder holding the busbar and extendable and contractible along the stacking direction.

### CROSS-REFERENCE TO RELATED APPLICATIONS

This application is based on and claims priority under 35 USC 119 from Japanese Patent Application No. 2022-080406 filed on May 16, 2022, the contents of which are incorporated herein by reference.

### TECHNICAL FIELD

The present disclosure relates to a busbar module.

### BACKGROUND ART

In the related art, a busbar module is used, for example, to be assembled to a battery assembly (a battery module in which a plurality of battery cells are stacked and arranged) as a driving power source mounted on an electric vehicle, a hybrid vehicle, or the like as disclosed in, for example, JP2014-220128A.

The busbar module described in JP2014-220128A includes a plurality of busbars that are stacked and connect a positive electrode and a negative electrode between adjacent battery cells, and a plurality of voltage detection lines that are connected to the plurality of busbars and monitor the battery cells, respectively. Each of the plurality of voltage detection lines has a general structure in which a core wire is covered with an insulating sheath.

Meanwhile, from a viewpoint of improving a function of the busbar module and the like, it is conceivable to provide an electronic component such as a fuse in each voltage detection circuit (that is, a circuit corresponding to each voltage detection line connecting the busbar to a processing device such as an ECU). However, in the busbar module of the related art, since the voltage detection circuit is not designed on an assumption that such an electronic component is mounted, it is difficult to mount the electronic components on the individual voltage detection circuits. Further, when the electronic component is carelessly provided on the voltage detection circuit of the busbar module in the related art, there is a possibility that an original function as the busbar module (for example, a deformation of the battery assembly, and a countermeasure to a manufacturing variation) is impaired.

### SUMMARY OF INVENTION

The present disclosure provides a busbar module in which electronic components are mounted on voltage detection circuits without impairing an original function of the busbar module.

According to the present disclosure, a busbar module is attached to a battery assembly in which a plurality of single cells are stacked. The busbar module includes a main line circuit body including a plurality of electric wires, and disposed to extend along a stacking direction of the plurality of single cells, a relay circuit body including a circuit board having a wiring pattern, the wiring pattern being electrically connected to at least one of the electric wires extending to branch from the main line circuit body, a busbar connected to an electrode of each of the plurality of single cells, an electronic component attached to a mounting face of the relay circuit body to connect the wiring pattern to the busbar, and a holder holding the busbar and extendable and contractible along the stacking direction.

The present disclosure has been briefly described above. Further, details of the present disclosure will be further clarified by reading modes for carrying out the disclosure described below with reference to the accompanying drawings.

### BRIEF DESCRIPTION OF DRAWINGS

FIG. 1 is a perspective view showing a busbar module according to the present embodiment;

FIG. 2 is a perspective view showing a battery assembly to which the busbar module shown in FIG. 1 is assembled;

FIG. 3 is a perspective view showing a state in which busbar is connected to each of a plurality of relay circuit bodies connected to a main line circuit body;

FIG. 4 is a perspective view showing one relay circuit body connected to the main line circuit body;

FIG. 5 is a perspective view showing a state in which the busbar is connected to the relay circuit body connected to the main line circuit body;

FIG. 6 is a perspective view showing a holder and a cover shown in FIG. 1;

FIG. 7 is a bottom view showing a connection portion between the relay circuit body and the busbar; and

FIG. 8 is a perspective view showing a state in which the relay circuit body is connected to a branch line extending so as to branch from the main line circuit body.

### DESCRIPTION OF EMBODIMENTS

### Embodiment

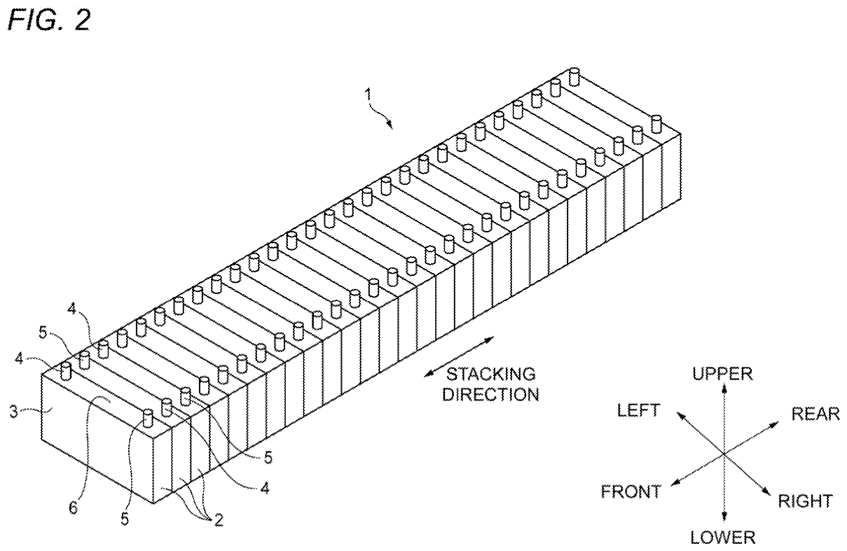

Hereinafter, a busbar module 10 according to an embodiment of the present disclosure will be described with reference to the drawings. The busbar module 10 according to the present embodiment is used, for example, to be assembled to a long battery assembly 1 (see FIG. 2. a battery module in which a plurality of single cells are stacked and arranged) as a driving power source mounted on an electric vehicle.

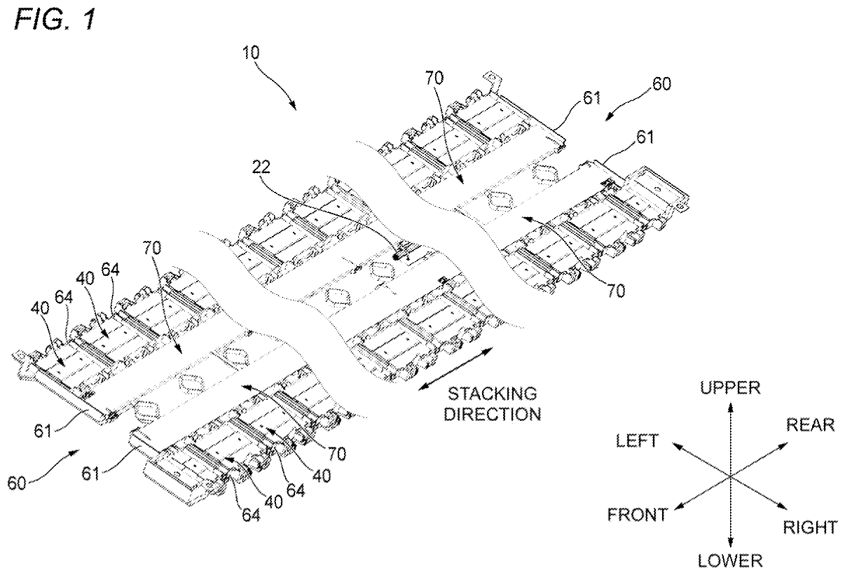

Hereinafter, for convenience of description, “front”, “rear”, “left”, “right”, “upper”, and “lower” are defined as illustrated in FIG. 1. A “front-rear direction”, a “left-right direction”, and an “upper-lower direction” are orthogonal to each other. The front-rear direction coincides with a stacking direction (see FIGS. 1 and 2) of the plurality of single cells 2 constituting the battery assembly 1. Note that these directions are defined for convenience of description, and do not necessarily correspond to the front-rear direction, the left-right direction, and the upper-lower direction of the vehicle when the busbar module 10 is mounted on a vehicle.

First, as preparation for describing the busbar module 10, the battery assembly 1 to which the busbar module 10 is attached will be described with reference to FIG. 2. As shown in FIG. 2, the battery assembly 1 is formed by stacking a plurality of rectangular flat plate-shaped single cells 2 extending in the upper-lower direction and the left-right direction in the front-rear direction. Each of the plurality of single cells 2 includes a battery body 3 having a rectangular flat plate shape, and a positive electrode 4 and a negative electrode 5 protruding upward from both left and right end portions of an upper face 6 of the battery body 3.

In the battery assembly 1, by reversing positions in the left-right direction of the positive electrodes 4 and the negative electrodes 5 of the single cells 2 adjacent to each other in the front-rear direction, the plurality of single cells 2 are stacked such that the positive electrode 4 and the negative electrode 5 are alternately arranged in the front-rear direction at each of the left end portion and the right end portion of an upper face of the battery assembly 1.

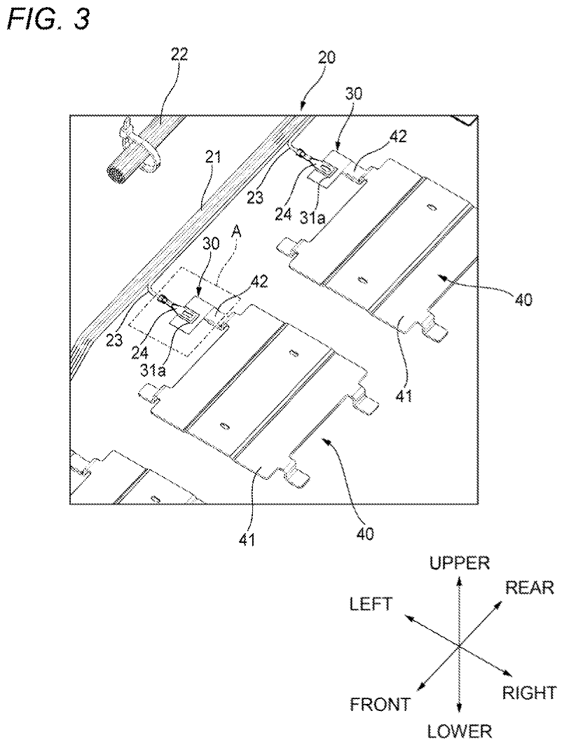

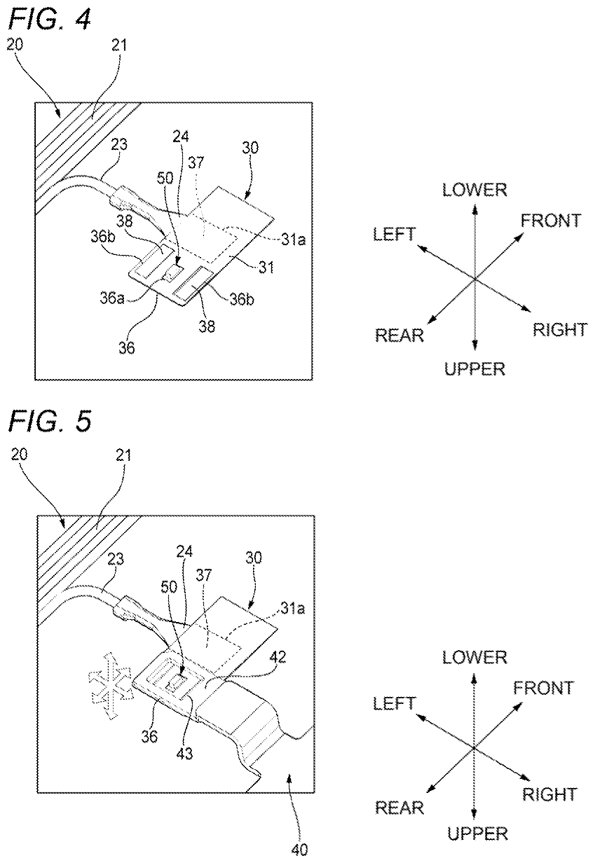

Hereinafter, the busbar module 10 will be described. As illustrated in FIGS. 1, 3, and 6, the busbar module 10 includes a main line circuit body 20 (see FIG. 3) extending in the front-rear direction, a plurality of relay circuit bodies 30 connected to the main line circuit body 20, a plurality of busbars 40 respectively connected to the plurality of relay circuit bodies 30, a plurality of electronic components 50 respectively mounted on the plurality of relay circuit bodies 30, a holder 60 holding the main line circuit body 20, the relay circuit bodies 30, and the busbars 40, and a cover 70 covering the main line circuit body 20 and the relay circuit bodies 30. Hereinafter, each member constituting the busbar module 10 will be described in order.

First, the main line circuit body 20 will be described. As can be understood from FIGS. 1 and 3, the main line circuit body 20 includes a pair of left and right trunk lines 21 that include a plurality of electric wires and extend in the front-rear direction at intervals in the left-right direction, and a collection portion 22 in which one end portions of all the electric wires configuring the pair of trunk lines 21 are collected. A connector (not shown) electrically connected to an external voltage detection device (not shown) or the like is mounted on the collection portion 22. Each of the electric wires has a structure in which a periphery of a conductor core wire is surrounded by an insulating sheath. Therefore, the adjacent electric wires are not electrically connected (short-circuited) to each other.

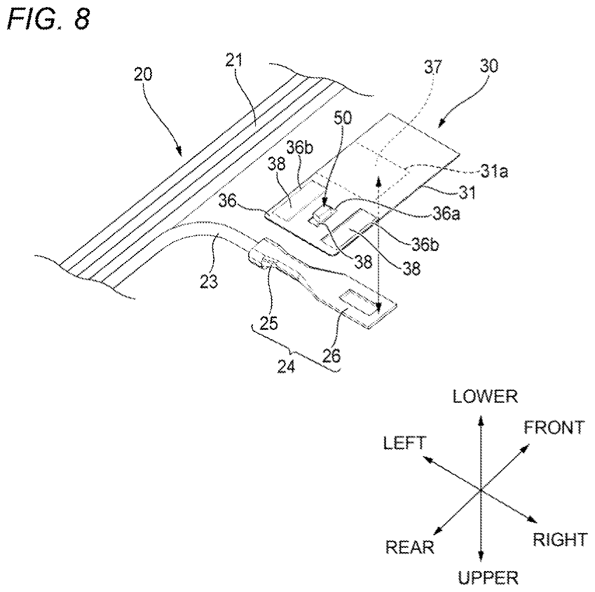

From a plurality of positions in the front-rear direction of each of the pair of left and right trunk lines 21, the other end portion (hereinafter, referred to as “branch line 23”) of the corresponding one electric wire constituting the trunk line 21 extends outward in the left-right direction so as to branch from the trunk line 21 (see FIG. 3). The corresponding relay circuit body 30 is connected to each of the branch line 23 via a metal terminal 24. As shown in FIG. 8, the terminal 24 integrally includes a crimp portion 25 to which the conductor core wire of the branch line 23 is crimped and fixed, and a flat plate-shaped connection portion 26 connected to a wiring pattern 37 exposed from an opening portion 31a to be described later of the relay circuit body 30.

When the relay circuit body 30 is connected to the main line circuit body 20, the connection portion 26 of the terminal 24 connected to the branch line 23 and the wiring pattern 37 of the relay circuit body 30 are electrically connected to each other by soldering (see FIG. 8). Accordingly, the wiring pattern 37 of each relay circuit body 30 is electrically connected to the external voltage detection device (not shown) via the terminal 24, the branch line 23, the trunk line 21, the collection portion 22, and the connector mounted on the collection portion 22 individually (that is, in a state insulated from the wiring pattern 37 of the other relay circuit body 30) in this order. Since the relay circuit body 30 is connected to the trunk line 21 (main line circuit body 20) via the branch line 23 that can be easily bent, the relay circuit body 30 has high flexibility of relative movement with respect to the main line 21 (main line circuit body 20) in the front-rear, left-right, and upper-lower directions (see white arrows in FIG. 5). Typically, the soldering may be performed by a method (a so-called pulse heat soldering) in which, after a paste-shaped solder is sandwiched between the connection portion 26 of the terminal 24 and the wiring pattern 37, a heater chip capable of heating the solder to a temperature at which the solder can be melted is pressed against a soldering portion and the heater chip is heated to perform the soldering. The soldering may be performed by a reflow soldering process using a heating furnace. Further, the electrical connection between the connection portion 26 of the terminal 24 and the wiring pattern 37 may be performed by ultrasonic welding or using a conductive adhesive instead of the above-described soldering.

Next, the relay circuit body 30 will be described. The relay circuit body 30 is implemented by a flexible board (FPC) which can be easily bent. As illustrated in FIG. 3 and the like, the relay circuit body 30 is connected, via the terminal 24, to the branch line 23 branching outward in the left-right direction from each of the pair of left and right trunk lines 21 of the main line circuit body 20.

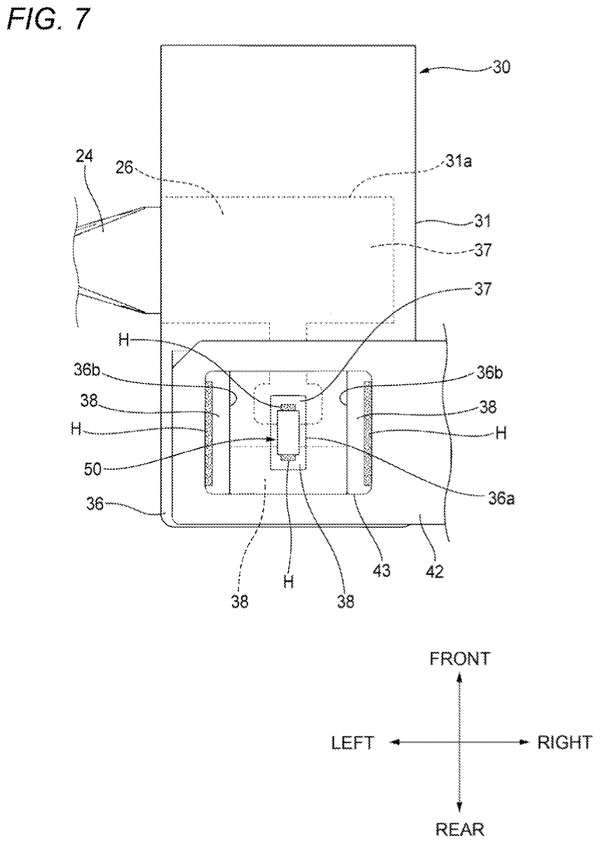

As shown in FIG. 8, the relay circuit body 30 as a whole has a flat plate shape that extends in the front-rear direction and the left-right direction and is long in the front-rear direction. An entire surface of the relay circuit body 30 is formed of a resin layer except opening portions 31a, 36a, and 36b (see FIG. 8) to be described later, and includes the wiring patterns 37, 38 (see FIGS. 7 and 8) to be described later. Each of the wiring patterns 37, 38 is typically a conductor pattern made of copper and extending in a strip shape.

A terminal-side connection portion 31 is provided at a substantially central portion of the relay circuit body 30 in the front-rear direction. The terminal-side connection portion 31 is a portion connected to the terminal 24 that is connected to the branch line 23 branching from the trunk line 21 (main line circuit body 20). The pair of opening portions 31a from which the resin layer on the surface is removed and the wiring pattern 37 is exposed are provided on an upper face of the terminal-side connection portion 31 (see FIG. 8). The wiring pattern 37 exposed to the opening portion 31a extends through an inside of the relay circuit body 30 to the opening portion 36a provided in a busbar-side connection portion 36 to be described later (see FIGS. 7 and 8).

A busbar-side connection portion 36 is provided at a rear end portion of the relay circuit body 30. The busbar-side connection portion 36 is a portion to which the busbar 40 is connected (see FIG. 5 and the like). As shown in FIGS. 7 and 8, on a lower face of the busbar-side connection portion 36, an opening portion 36a from which the resin layer on the surface is removed is provided at a central portion in the left-right direction, and opening portions 36b from which the resin layer on the surface is removed are formed at a pair of left and right positions sandwiching the opening portion 36a in the left-right direction. An end portion of the wiring pattern 37 is exposed to a front side region of the opening portion 36a, and a part of the wiring patterns 38 separated from the wiring pattern 37 and included in the busbar-side connection portion 36 are exposed to a rear side region of the opening portion 36a. In each of the pair of opening portions 36b, the other part of the wiring pattern 38 is exposed.

When the busbar 40 is connected to the relay circuit body 30, the wiring patterns 38 exposed to the pair of opening portions 36b and an extending portion 42 (see FIGS. 3, 5, and 7) described later of the busbar 40 are soldered using solders H (see FIG. 7).

The electronic component 50 is mounted on the opening portion 36a of the relay circuit body 30 (see FIG. 8 and the like). The electronic component 50 is typically a chip fuse. The electronic component 50 is soldered to the wiring pattern 38 and the wiring pattern 37 using the solder H (see FIG. 7) so as to straddle the wiring pattern 38 and the wiring pattern 37 exposed to the opening portion 36a. Accordingly, the wiring patterns 38 (that is, the busbar 40) and the wiring pattern 37 (that is, the branch line 23 branching from the main line circuit body 20) are electrically connected to each other via the electronic component 50. Accordingly, it is possible to provide the electronic component 50 on each of the voltage detection circuits connecting the busbars 40 and the voltage detection device.

The electronic component 50 is preferably mounted on the relay circuit body 30 in a state before the relay circuit body 30 is connected to the long main line circuit body 20 formed to be long in the front-rear direction (a state of the relay circuit body 30 alone). By mounting the electronic component 50 in the state of the relay circuit body 30 alone, it is not necessary to provide a large mounting apparatus as compared with a case where the main line circuit body 20 and the relay circuit body 30 are implemented by a common circuit board (for example, a flexible board). In other words, since the main line circuit body 20 and the relay circuit body 30 are separate bodies, the electronic component 50 can be properly mounted on the relay circuit body 30 regardless of the length and size of the main line circuit body 20, and a manufacturing cost of the busbar module 10 can be reduced. In addition, since the main line circuit body 20 includes a plurality of electric wires, it is easy to replace locations of the electric wires as compared with the case where the main line circuit body 20 is implemented by the circuit board. Therefore, it is easy to arrange the electric wires side by side in a desired order (for example, in the order of potentials of the busbars 40) in the connector to be mounted on the collection portion 22.

Next, the busbar 40 will be described. The busbar 40 is formed by one metal plate being subjected to pressing processing (punching processing), bending processing, or the like. As shown in FIG. 3, the busbar 40 includes a busbar body 41 having a substantially rectangular flat plate shape, and an extending portion 42 extending inward in the left-right direction from a rear end portion of an inner edge portion in the left-right direction extending in the front-rear direction of the busbar body 41. A through hole 43 (see FIGS. 5 and 7) that opens in a thickness direction (vertical direction) is formed at an extending end portion of the extending portion 42. The through hole 43 functions as an escape portion for avoiding interference between the extending end portion of the extending portion 42 of the busbar 40 and the electronic component 50 when the busbar 40 is connected to the relay circuit body 30.

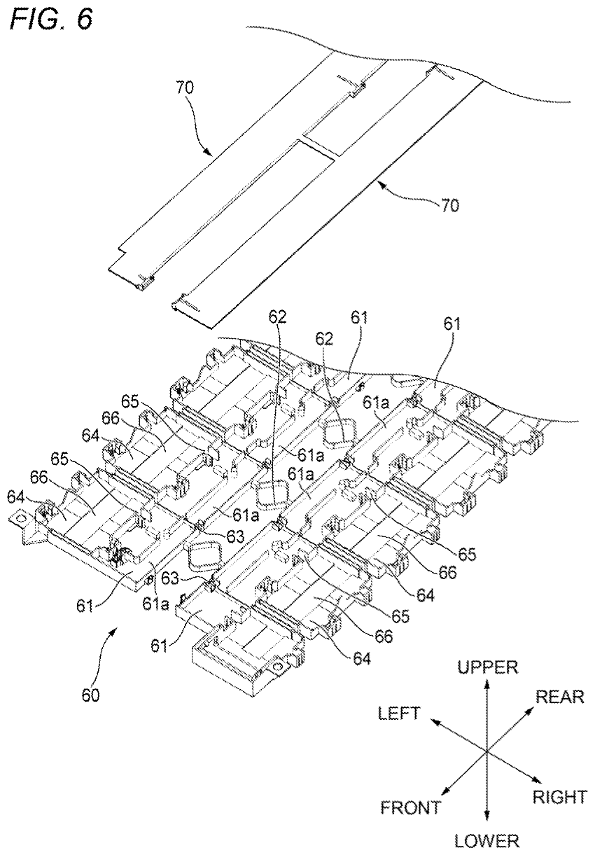

Next, the holder 60 will be described. The holder 60 is a resin molded product, and as shown in FIG. 6, integrally includes a pair of left and right strip-shaped circuit body holding portions 61 that are disposed at intervals in the left-right direction and each of which extends in the front-rear direction, and a plurality of connecting portions 62 that connect the pair of left and right circuit body holding portions 61 in the left-right direction at a plurality of positions in the front-rear direction. The pair of left and right main line circuit bodies 20 (trunk lines 21) of the main line circuit body 20 and the plurality of relay circuit bodies 30 respectively connected to the plurality of branch lines 23 branching from the main line circuit body 20 (trunk lines 21) are placed on the pair of left and right circuit body holding portions 61.

Specifically, each of the pair of circuit body holding portions 61 extending in the front-rear direction includes a plurality of divided bodies 61a arranged side by side in the front-rear direction, and extension and contraction portions 63 each connecting the divided bodies 61a adjacent to each other in the front-rear direction to each other in the front-rear direction. Each of the extension and contraction portions 63 has a shape that is easily extended and contracted in the front-rear direction due to elastic deformation. Therefore, the pair of circuit body holding portions 61 are extendable and contractible along the front-rear direction.

With respect to each of the pair of left and right circuit body holding portions 61, each of the plurality of divided bodies 61a arranged in the front-rear direction is integrally provided with a busbar holding portion 64 so as to be adjacent to an outer side in the left-right direction. That is, the plurality of busbar holding portions 64 are arranged side by side in the front-rear direction on the outer side in the left-right direction of each of the pair of left and right circuit body holding portions 61. Since each of the busbar holding portions 64 is provided in the corresponding divided body 61a, an interval in the front-rear direction between the busbar holding portions 64 adjacent to each other in the front-rear direction can be changed by a function of the extension and contraction portion 63.

The busbar body 41 of the busbar 40 is accommodated in the busbar holding portion 64. Therefore, the busbar holding portion 64 has a substantially rectangular box shape opening upward corresponding to an outer shape of the busbar body 41. A notch 65 is formed in a portion of a rectangular frame-shaped side wall portion of the busbar holding portion 64 where the extending portion 42 of the busbar 40 crosses, in order to avoid interference with the extending portion 42. An opening 66 extending in the front-rear direction is formed in a bottom wall portion of the busbar holding portion 64. When the holder 60 is attached to the battery assembly 1, the positive electrodes 4 and the negative electrodes 5 that are adjacent to each other in the front-rear direction are disposed in the openings 66 of the busbar holding portions 64.

Next, the cover 70 will be described. The cover 70, which is a resin molded product, has a function of covering the pair of left and right trunk lines 21 of the main line circuit body that is long in the front-rear direction, and the plurality of relay circuit bodies 30 that are respectively connected to the plurality of branch lines 23 branching from the trunk lines 21, the main line circuit body 20 and the plurality of relay circuit bodies 30 being placed on the pair of left and right circuit body holding portions 61 that are long in the front-rear direction of the holder 60 (see FIG. 1). Therefore, as shown in FIG. 6, the cover 70 has a strip shape formed to be long in the front-rear direction. The members constituting the busbar module 10 have been described above.

In an attachment completion state in which the busbar module 10 is attached to the battery assembly 1, in the battery assembly 1, the plurality of stacked single cells 2 are electrically connected in series via the plurality of busbars 40. Further, each busbar 40 is electrically connected to the external voltage detection device via the wiring pattern 38 of the corresponding relay circuit body 30, the electronic component 50, the wiring pattern 37 of the corresponding relay circuit body 30, the terminal 24, the corresponding branch line 23, the trunk line 21, the collection portion 22, and the connector mounted on the collection portion 22 in this order. Accordingly, a voltage (potential) of each busbar 40 can be individually detected by the external voltage detection device. When an excessive current equal to or greater than a rated current flows in the electronic component 50 for some reason, an electrical connection between the wiring patterns 37,38 is cut off by the electronic component 50 due to an effect of a fuse function of the electronic component 50. Accordingly, the excessive current is prevented from flowing into the voltage detection device, so that the voltage detection device can be protected.

In the use state of the battery assembly 1 to which the busbar module 10 is attached, each of the single cells 2 constituting the battery assembly 1 may expand or contract in the stacking direction (the front-rear direction) due to operation heat associated with charging and discharging, a temperature of an external environment, and the like. As a result, the battery assembly 1 may deform to expand and contract in the stacking direction (front-rear direction). Further, the size of the battery assembly 1 in the stacking direction (the front-rear direction) may vary for each of the manufactured battery assemblies 1 due to an assembly tolerance when the plurality of single cells 2 are stacked and arranged (a manufacturing variation may occur).

In this regard, in the busbar module 10, even if the expansion and contraction of the battery assembly 1 in the stacking direction (the front-rear direction) due to the thermal deformation of each single cell 2 and the manufacturing variation of the battery assembly 1 occur, since each of the plurality of extension and contraction portions 63 of the holder 60 extends and contracts in the front-rear direction, and the branch line 23 branching from the main line circuit body 20 (the trunk line 21) is easily bent, the expansion and contraction due to the thermal deformation of the battery assembly 1 and the manufacturing variation can be easily absorbed.

### Operation and Effect

As described above, according to the busbar module 10 according to the present embodiment, the relay circuit body 30 implemented by the circuit board is electrically connected to the electric wire (branch line 23) extending to branch from the main line circuit body 20 (trunk line 21) including the plurality of electric wires. The electronic component 50 is attached to (that is, mounted on) the relay circuit body 30, and the wiring pattern 38 of the relay circuit body 30 and the busbar 40 are connected to each other via the electronic component 50. That is, the busbar 40 and the electric wire (branch line 23) are electrically connected to each other via the electronic component 50 of the relay circuit body 30. Accordingly, it is possible to provide the electronic component 50 on each voltage detection circuit. Further, when the battery assembly 1 expands and contracts in the stacking direction due to the thermal deformation of each single cell 2, each busbar 40 can move in the stacking direction of the single cells 2 by bending or the like of the branch line 23. Similarly, when the branch line 23 is bent or the like, variations in the size of the battery assembly 1 in the stacking direction due to the assembly tolerance of the single cells 2 can be absorbed. In other words, the busbar module 10 according to the present embodiment can easily cope with the expansion and contraction and the manufacturing variation of the battery assembly 1 due to the deformation of the branch line 23. Therefore, the busbar module 10 according to the present embodiment has a configuration in which the electronic components are mounted on the voltage detection circuits without impairing an original function of the busbar module.

Further, according to the busbar module 10 of the present embodiment, the main line circuit body 20 and the relay circuit body 30 are prepared as separate bodies and electrically connected. When the electronic component 50 is attached to (that is, mounted on) the relay circuit body 30 prepared as the separate body, it is not necessary to provide a large mounting apparatus for mounting the electronic component 50 as compared with a case where the main line circuit body 20 and the relay circuit body 30 are implemented by an integrated circuit board (for example, a flexible board). In other words, regardless of the length and size of the main line circuit body 20, the electronic component 50 can be properly mounted on the relay circuit body 30 by using a general mounting apparatus, and the manufacturing cost of the busbar module 10 can be reduced. In addition, as compared with the case where the main line circuit body 20 is implemented by circuit board, since it is easy to replace locations of the electric wires, it is easy to arrange the electric wires side by side in the desired order (for example, in the order of the potentials of the busbars 40) to an input connector or the like of a control device such as an ECU.

### Other Embodiments

The present disclosure is not limited to the above-described embodiments, and various modifications can be adopted within the scope of the present disclosure. For example, the present disclosure is not limited to the above-described embodiment, and modifications, improvements, and the like can be made as appropriate. In addition, materials, shapes, dimensions, numbers, arrangement positions, and the like of the respective constituent elements in the above embodiment are freely selected and are not limited as long as the present disclosure can be implemented.

In the above embodiment, the relay circuit body 30 is implemented by the flexible board (FPC). On the other hand, the relay circuit body 30 may be implemented by a rigid board.

Further, in the above embodiment, the wiring pattern 37 of the relay circuit body 30 is indirectly connected to the conductor core wire of the branch line 23 via the terminal 24 connected to the conductor core wire of the branch line 23 branching from the main line circuit body 20. On the other hand, the wiring pattern 37 of the relay circuit body 30 may be directly connected to the conductor core wire of the branch line 23 branching from the main line circuit body 20.

Here, features of the above-described embodiment of the busbar module 10 according to the present disclosure will be briefly summarized and listed in the following first to fourth aspects.

According to a first aspect of the present disclosure, a busbar module (10) is attached to a battery assembly (1) in which a plurality of single cells (2) are stacked. The busbar module (10) includes a main line circuit body (20) including a plurality of electric wires, and disposed to extend along a stacking direction of the plurality of single cells (2), a relay circuit body (30) including a circuit board having a wiring pattern (37, 38), the wiring pattern (37, 38) being electrically connected to at least one of the electric wires extending to branch from the main line circuit body (20), a busbar (40) connected to an electrode (4, 5) of each of the plurality of single cells (2), an electronic component (50) attached to a mounting face of the relay circuit body (30) to connect the wiring pattern (38) to the busbar (40), and a holder (60) holding the busbar (40) and extendable and contractible along the stacking direction.

According to the busbar module having the configuration of the above first aspect, the relay circuit body implemented by the circuit board is electrically connected to the electric wire (hereinafter, also referred to as a branch line) that extends to branch from the main line circuit body (hereinafter, also referred to as a trunk line) including the plurality of electric wires. The electronic component is attached to (that is, mounted on) the relay circuit body, and the wiring pattern of the relay circuit body and the busbar are connected to each other via the electronic component. That is, the busbar and the electric wire (branch line) are electrically connected to each other via the electronic component of the relay circuit body. Accordingly, it is possible to provide the electronic component on each voltage detection circuit. Further, when the battery assembly extends and contracts in the stacking direction due to thermal deformation of each single cell, each busbar can move in the stacking direction of the single cells by bending or the like of the branch line. Similarly, by bending or the like of the branch line, variations in the size of the battery assembly in the stacking direction due to an assembly tolerance of the single cells can be absorbed. In other words, the busbar module of the present configuration can easily cope with the extension and contraction and the manufacturing variation of the battery assembly due to deformation of the branch lines. Therefore, the busbar module of the present configuration has a configuration in which the electronic components are mounted on the voltage detection circuits without impairing an original function of the busbar module.

Further, according to the busbar module having the above configuration, the main line circuit body and the relay circuit body are prepared as separate bodies and electrically connected. When the electronic component is attached to (that is, mounted on) the relay circuit body prepared as a separate body, it is not necessary to provide a large mounting apparatus for mounting the electronic component as compared with a case where the main line circuit body and the relay circuit body are implemented by an integrated circuit board (for example, a single continuous flexible board). In other words, regardless of the length and size of the main line circuit body, the electronic component can be properly mounted on the relay circuit body by using a general mounting apparatus, and a manufacturing cost of the busbar module can be reduced. In addition, as compared with the case where the main line circuit body is implemented by the circuit board, since it is easy to replace locations of the electric wires, it is easy to arrange the electric wires side by side in a desired order (for example, in the order of potentials of the busbars) to an input connector or the like of a control device such as an ECU.

According to a second aspect of the present disclosure, the circuit board of the relay circuit body (30) is a flexible board or a rigid board.

According to the busbar module having the configuration of the above second aspect, by using the flexible board or the rigid board, the relay circuit body on which the electronic component is mounted as described above can be manufactured using an existing general-purpose mounting apparatus.

According to a third aspect of the present disclosure, the wiring pattern (37) of the relay circuit body (30) is directly connected to a conductor core wire of the at least one of the electric wires (23) or connected to the conductor core wire via a terminal (24) connected to the conductor core wire.

According to the busbar module having the configuration of the above third aspect, the wiring pattern of the relay circuit body is directly connected to the conductor core wire of the electric wire (branch line), or is indirectly connected to the conductor core wire via the terminal connected to the conductor core wire. By using the existing electrical connection technology, the relay circuit body can be introduced into the busbar module without requiring a large cost. This connection may be appropriately selected in consideration of the cost, a connection strength, and the like required for connection processing. For example, a method such as soldering, ultrasonic bonding, or bonding using a conductive adhesive can be used for this connection.

What is claimed is:

1. A busbar module to be attached to a battery assembly in which a plurality of single cells are stacked, the busbar module comprising:
a main line circuit body including a plurality of electric wires, and disposed to extend along a stacking direction of the plurality of single cells;
a relay circuit body including a circuit board having a wiring pattern, the wiring pattern being electrically connected to at least one of the electric wires extending to branch from the main line circuit body;
a busbar to be connected to an electrode of each of the plurality of single cells;
an electronic component attached to a mounting face of the relay circuit body to connect the wiring pattern to the busbar; and
a holder holding the busbar and extendable and contractible along the stacking direction.

2. The busbar module according to claim 1,
wherein the circuit board of the relay circuit body includes a flexible board.

3. The busbar module according to claim 1,
wherein the circuit board of the relay circuit body includes a rigid board.

4. The busbar module according to claim 1,
wherein the wiring pattern of the relay circuit body is directly connected to a conductor core wire of the at least one of the electric wires.

5. The busbar module according to claim 1,
wherein the wiring pattern of the relay circuit body is connected to a conductor core wire of the at least one of the electric wires via a terminal connected to the conductor core wire.
